(19) United States
(12) Patent Application Publication
(10) Pub. No.: US 2020/0331141 A1
(43) Pub. Date: Oct. 22, 2020

(54) ROBOT WAIST SKELETON AND ROBOT

(71) Applicants: CLOUDMINDS (BEIJING) TECHNOLOGIES CO., LTD., Beijing (CN); INNFOS DRIVE(BEIJING)TECHNOLOGIES CO., LTD., Beijing (CN)

(72) Inventors: Haotian CUI, Beijing (CN); Xunge YAN, Beijing (CN); William Xiao-qing HUANG, Beijing (CN); Cheng LUO, Guilin (CN); Yufeng ZHANG, Beijing (CN)

(21) Appl. No.: 16/806,879

(22) Filed: Mar. 2, 2020

(30) Foreign Application Priority Data
Mar. 1, 2019 (CN) 201910154368.6

(51) Int. Cl. B25J 9/00

(52) U.S. Cl. CPC B25J 9/0009

(57) ABSTRACT

A robot waist skeleton includes: a waist inner skeleton; and a waist outer skeleton, surrounding the waist inner skeleton, the waist outer skeleton being connected to the waist inner skeleton.

### CROSS-REFERENCE TO RELATED APPLICATIONS

This application claims priority to Chinese Patent Application No. 201910154368.6, filed with the Chinese Patent Office on Mar. 1, 2019, titled “ROBOT WAIST SKELETON AND ROBOT”, the entire contents of which ale incorporated herein by reference.

### TECHNICAL FIELD

Embodiments of the present application relate to the technical field of robots, and in particular, relate to a robot waist skeleton and a robot.

### BACKGROUND

The waist skeleton of a robot is a hinge structure bridging an upper body and a lower body of the robot, and is a key component ensuring high flexibility and high freedom of the robot.

During the implementation of the present application, the inventors have identified that: At present, a waist structure of a robot is generally defined by directly lapping a waist skeleton of the robot to a waist skin. In this method for defining the structure of the robot waist, when the appearance and shape of the robot waist need to be changed, the whole waist skeleton needs to be replaced, which is troublesome, and causes a high cost.

### SUMMARY

An embodiment of the present application provides a robot waist skeleton. The robot waist skeleton includes a waist inner skeleton; and a waist outer skeleton which surrounds the waist inner skeleton, wherein the waist outer skeleton is connected to the waist inner skeleton.

Another embodiment of the present application provides a robot. The robot includes the robot waist skeleton as described above.

### BRIEF DESCRIPTION OF THE DRAWINGS

For clearer descriptions of the technical solutions according to the specific embodiments of the present application or the technical solutions in the related art, the accompanying drawings incorporated for illustrating the specific embodiments or the related art are briefly described hereinafter. In all the accompanying drawings, like elements or parts are generally denoted by like reference numerals. In the accompanying drawings, various elements or parts are not necessarily drawn according to the actual scale.

FIG. 1 is a schematic view of a robot waist skeleton according to an embodiment of the present application;

FIG. 2 is an exploded view of a waist outer skeleton in the robot waist skeleton according to an embodiment of the present application;

FIG. 3 is an exploded view of a waist outer skeleton lower part in the robot waist skeleton according to an embodiment of the present application;

FIG. 4 is a first exploded view of a waist outer skeleton middle part in the robot waist skeleton according to an embodiment of the present application;

FIG. 5 is a second exploded view of a waist outer skeleton middle part in the robot waist skeleton according to an embodiment of the present application;

FIG. 6 is a third exploded view of a waist outer skeleton middle part in the robot waist skeleton according to an embodiment of the present application;

FIG. 7 is an exploded view of a waist outer skeleton upper part in the robot waist skeleton according to an embodiment of the present application;

FIG. 8 is a front view of a robot waist skeleton according to an embodiment of the present application; and

FIG. 9 is a rear view of a robot waist skeleton according to an embodiment of the present application.

### REFERENCE NUMERALS AND DENOTATIONS THEREOF

Robot waist skeleton 20;
Waist outer skeleton 21;
Waist inner skeleton 22;
Waist outer skeleton lower part 211;
Waist outer skeleton middle part 212;
Waist outer skeleton upper part 213;
Waist outer skeleton left lower part 2111;
Waist outer skeleton right lower part 2112;
First positioning pin 2111a;
Third positioning pin 2111b;
Second positioning pin 2112a;
Fourth positioning pin 2112b;
Waist outer skeleton middle front part 2121;
Waist outer skeleton middle rear part 2122;
First positioning hole 2121a;
Second positioning hole 2121b;
Fifth positioning pin 2121c;
Third positioning hole 2122a;
Fourth positioning hole 2122b;
Sixth positioning pin 2122c;
Fifth positioning hole 2131a;
Waist outer skeleton upper front part 2131;
Waist outer skeleton upper rear part 2132;
Sixth positioning hole 2132a;
Skin positioning groove 214.

### DETAILED DESCRIPTION

The embodiments containing the technical solutions of the present application are described in detail with reference to the accompanying drawings. The embodiments hereinafter are only used to clearly describe the technical solutions of the present application. Therefore, these embodiments are only used as examples, but are not intended to limit the protection scope of the present application.

It should be noted that unless otherwise specified, the technical terms and scientific terms used in the present application shall express general meanings that may be understood by a person skilled in the art.

In the description of some embodiments of the present application, it should be understood that the terms “central”, “longitudinal”, “transversal”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present application.

In addition, terms of “first”, “second” are only used for description, but shall not be understood as indication or implication of relative importance or implicit indication of the number of the specific technical features. In the description of the present application, the term “more” or “a plurality of” signifies at least two, unless otherwise specified.

In the description of the present application, it should be noted that unless otherwise specified and defined, the terms “mounted”, “coupled”, “connected” and “fixed” and derivative forms thereof shall be understood in a broad sense, which, for example, may be understood as fixed connection, detachable connection or integral connection; may be understood as mechanical connection or electrical connection, or understood as direct connection, indirect connection via an intermediate medium, or communication between the interiors of two elements or interactions between two elements. Persons of ordinary skill in the art may understand the specific meanings of the above terms in the present application according to the actual circumstances and contexts.

In the present application, unless otherwise specified or defined, by defining that a first feature is disposed “above” or “below” or “beneath” a second feature, it may be meant that the first feature is in direct contact with the second feature, or the first feature is in indirect contact with the second feature via an intermediate medium. In addition, by defining that a first feature is disposed “over” or “above” a second feature, it may be meant that the first feature is rightly over the second feature or is obliquely above the second feature, or the horizontal height of the first feature is greater than that of the second feature. In addition, by defining that a first feature is disposed “under” or “blow, or “beneath” a second feature, it may be meant that the first feature is rightly under the second feature or is obliquely below the second feature, or the horizontal height of the first feature is less than that of the second feature.

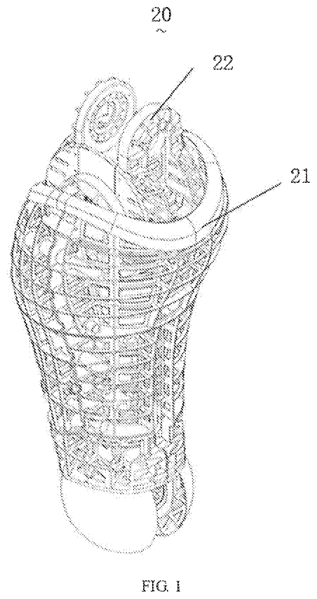

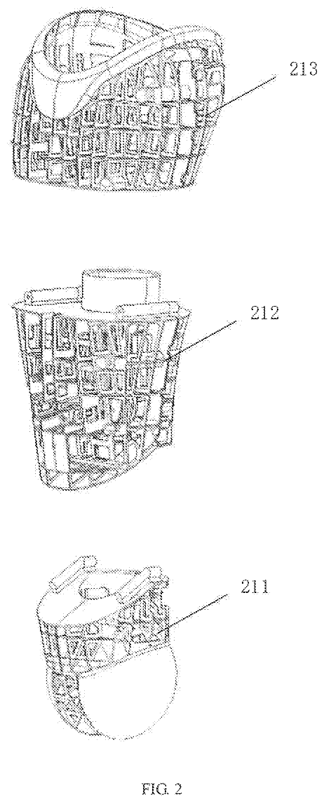

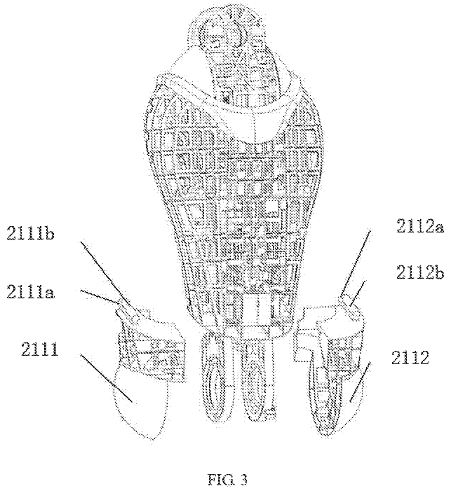

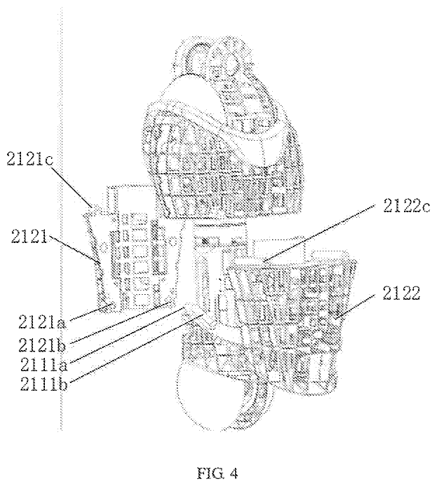

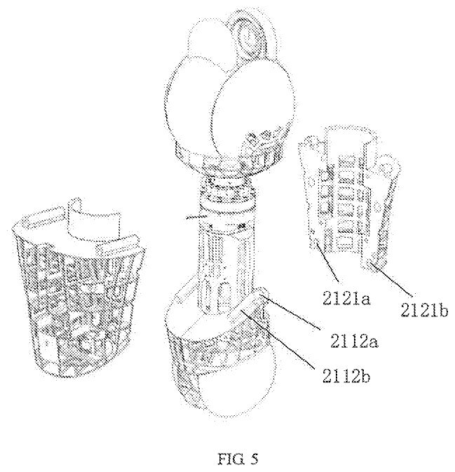

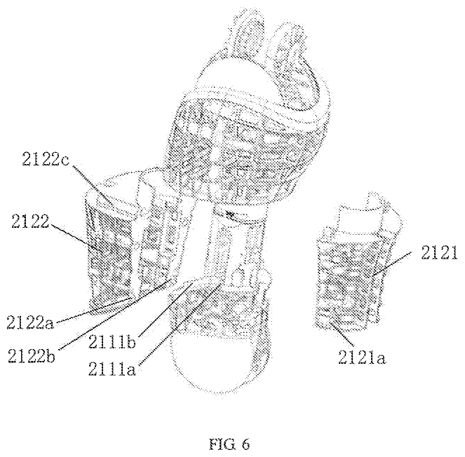

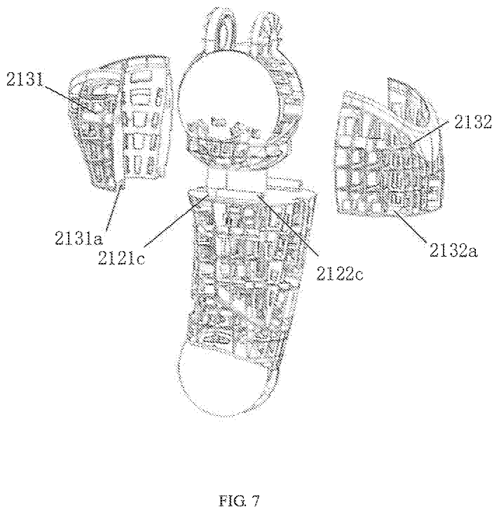

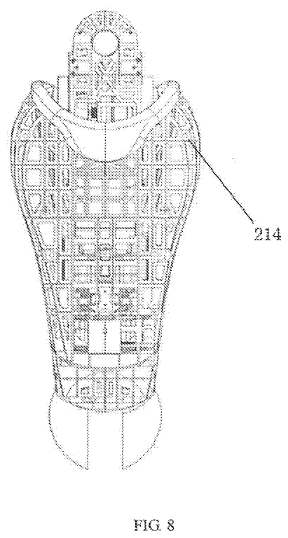

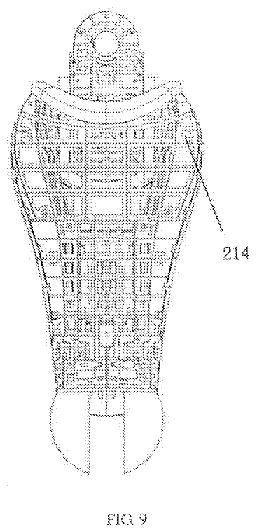

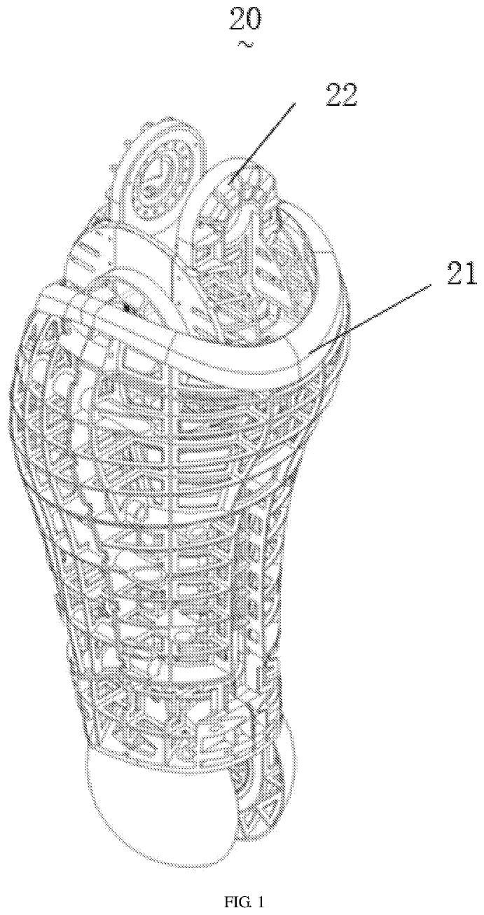

Referring to FIG. 1, a robot waist skeleton 20 includes a waist inner skeleton 22 and a waist outer skeleton 21. The waist outer skeleton 21 surrounds the waist inner skeleton 22, and is connected to the waist inner skeleton 22. The waist inner skeleton 22 is configured to define each movement joint of a robot waist, and the waist outer skeleton 21 is configured to define the appearance and shape of the robot waist.

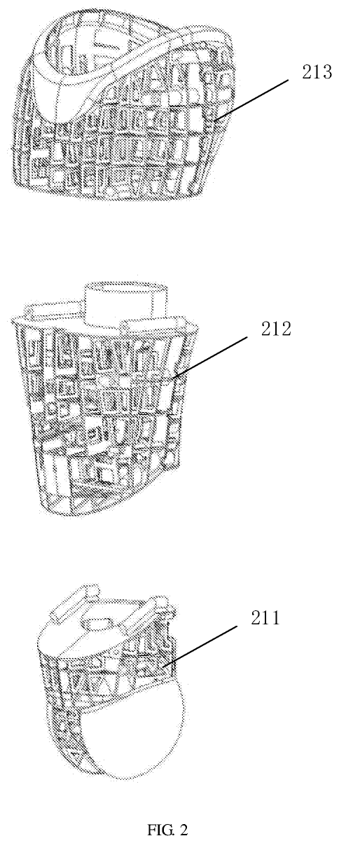

With respect to the waist outer skeleton 21, as illustrated in FIG. 2, the waist outer skeleton 21 includes a waist outer skeleton lower part 211, a waist outer skeleton middle part 212, and a waist outer skeleton upper part 213.

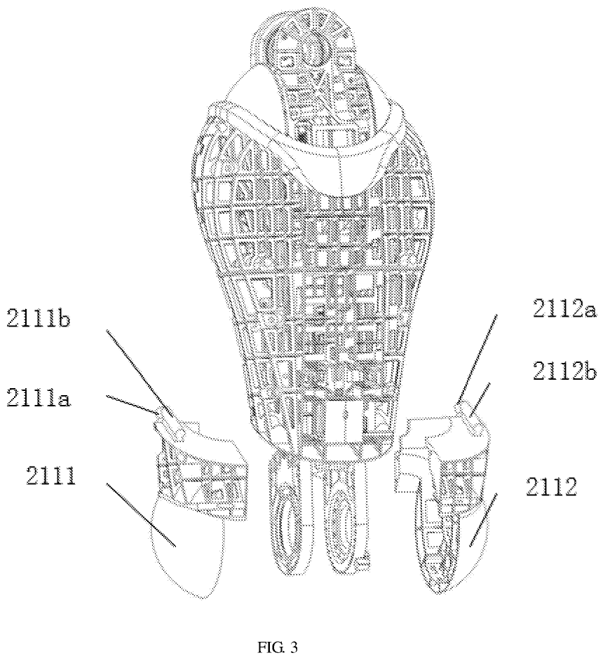

With respect to the waist outer skeleton lower part 211, as illustrated in FIG. 2 and FIG. 3, the waist outer skeleton lower part 211 includes a waist outer skeleton left lower part 2111 and a waist outer skeleton right lower part 2112. The waist outer skeleton left lower part 2111 is threaded to a lower part of the waist inner skeleton 22, and the waist outer skeleton right lower part 2112 is threaded to the waist outer skeleton left lower part 2111 and the lower part of the waist inner skeleton 22 respectively. The threaded fixing has the merits of reliable fixing and easy detachability, which is favorable to repair and part replacement. The waist outer skeleton right lower part 2112 is interconnected to the waist outer skeleton left lower part 2111, and both the waist outer skeleton right lower part 2112 and the waist outer skeleton left lower part 2111 surround the lower part of the waist inner skeleton 22, to wrap and protect the lower part of the waist inner skeleton 22, and define the appearance of the waist lower part of the robot. The waist outer skeleton left lower part 2111 is further provided with a first positioning pin 2111a and a third positioning pin 2111b. In addition, the waist outer skeleton right lower part 2112 includes a second positioning pin 2112a and a fourth positioning pin 2112b.

It should be noted that the waist outer skeleton left lower part 2111 is connected to the waist inner skeleton 22, and the waist outer skeleton right lower part 2112 is connected to the waist inner skeleton 22 in other modes, for example, welding connection, snap-fitting connection or the like, other than the connection modes as described above.

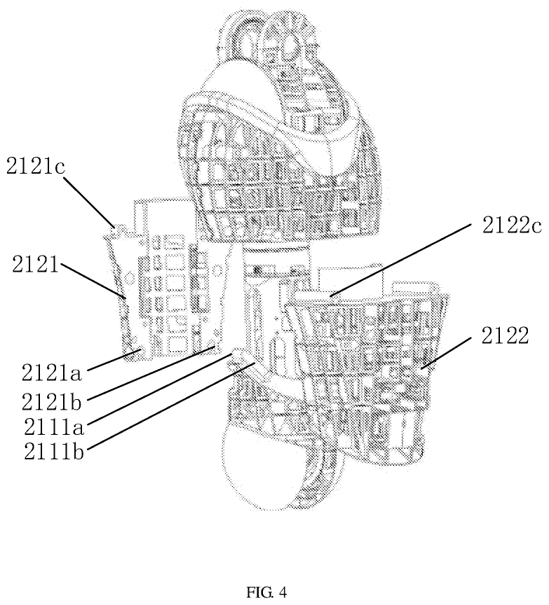

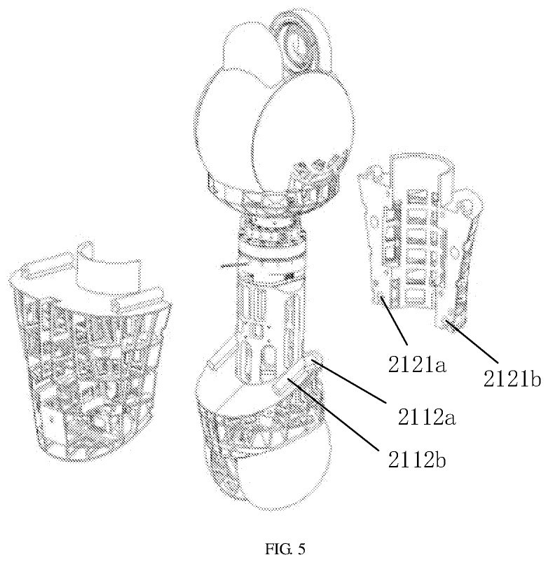

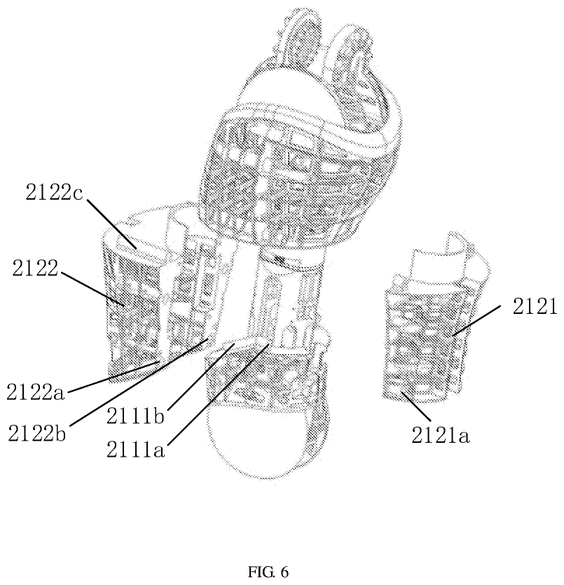

With respect to the waist outer skeleton middle part 212, as illustrated in FIG. 4 to FIG. 6, the waist outer skeleton middle part 212 includes a waist outer skeleton middle front part 2121 and a waist outer skeleton middle rear part 2122. The waist outer skeleton middle front part 2121 is provided with a first positioning hole 2121a, a second positioning hole 2121b, and a fifth positioning pin 2121c. The first positioning pin 2111a is inserted into the first positioning hole 2121a, and the second positioning pin 2112a is inserted into the second positioning hole 2121b, such that the waist outer skeleton middle front part 2121 is connected to the waist outer skeleton left lower part 2111 and the waist outer skeleton right lower part 2112 respectively. The waist outer skeleton middle rear part 2122 is provided with a third positioning hole 2122a, a fourth positioning hole 2122b, and a sixth positioning pin 2122c. The third positioning pin 2111b is inserted into the third positioning hole 2122a, and the fourth positioning pin 2112b is inserted into the fourth positioning hole 2122b, such that the waist outer skeleton middle rear part 2122 is connected to the waist outer skeleton left lower part 2111 and the waist outer skeleton right lower part 2112 respectively. In addition, the waist outer skeleton middle front part 2121 is further interconnected to the waist outer skeleton middle rear part 2122, and the waist outer skeleton middle front part 2121 and the waist outer skeleton middle rear part 2122 surround a middle part of the waist inner skeleton 22, such that the middle part of the waist inner skeleton 22 is wrapped and protected, and the shape of the waist middle part of the robot is defined. In some embodiments, the waist outer skeleton middle rear part 2122 may be further threadedly fixed to the waist outer skeleton middle front part 2121.

It may be understood that the waist outer skeleton middle rear part 2122 may be connected to the waist outer skeleton middle front part 2121, the waist outer skeleton middle front part 2121 may be connected to the waist outer skeleton left lower part 2111 and the waist outer skeleton right lower part 2112 respectively, and the waist outer skeleton middle rear part 2122 may be connected to the waist outer skeleton left lower part 2111 and the waist outer skeleton right lower part 2112 respectively in other modes other that the connection mode as described above, which are not described herein any further.

In some embodiments, the first positioning pin 2111a and the third positioning pin 2111b are connected to each other, and define an included angle less than or greater than 180 degrees; and the second positioning pin 2112a and the fourth positioning pin 2112b are connected to each other, and define an included angle less than or greater than 180 degrees. When the first positioning pin 2111a is inserted into the first positioning hole 2121a, the first positioning hole 2121a may not slide to the third positioning pin 2111b, and the third positioning pin 2111b may position the first positioning hole 2121a. Similarly, the first positioning pin 2111a may position the third positioning hole 2122a, the second positioning pin 2112a may position the fourth positioning hole 2122b, and the fourth positioning pin 2112b may position the second positioning hole 2121b.

It may be understood that the arrangements of first positioning pin 2111a, the third positioning pin 2111b, the second positioning pin 2112a, and the fourth positioning pin 2112b are not limited to the description as mentioned above, which are not described herein any further.

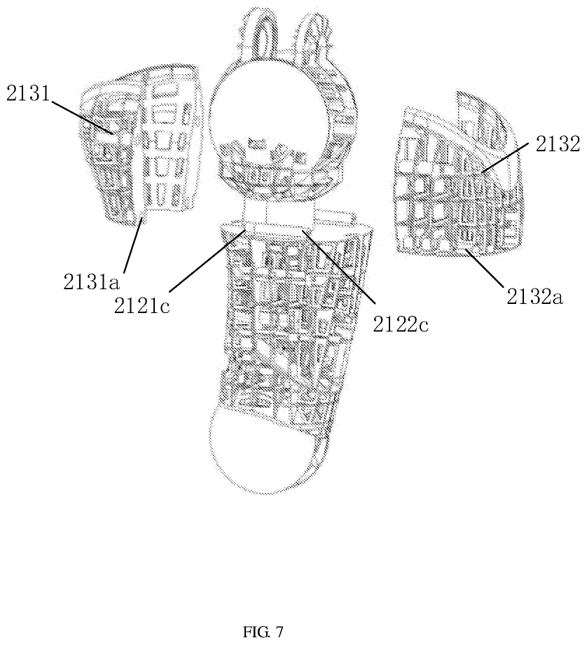

With respect to the waist outer skeleton upper part 213, as illustrated in FIG. 7, the waist outer skeleton upper part 213 includes a waist outer skeleton upper front part 2131 and a waist outer skeleton upper rear part 2132. The waist outer skeleton upper front part 2131 is provided with a fifth positioning hole 2131a, and the fifth positioning pin 2121c is inserted into the fifth positioning hole 2131a, such that the waist outer skeleton upper front part 2131 is connected to the waist outer skeleton middle front part 2121. The waist outer skeleton upper rear part 2132 is provided with a sixth positioning hole 2132a, and the sixth positioning pin 2122c is inserted into the sixth positioning hole 2132a, such that the waist outer skeleton upper rear part 2132 is connected to the waist outer skeleton middle rear part 2122. The waist outer skeleton upper front part 2131 is interconnected to the waist outer skeleton upper rear part 2132, and the waist outer skeleton upper front part 2131 and the waist outer skeleton upper rear part 2132 surround an upper part of the waist inner skeleton 22, to wrap and protect the upper part of the waist inner skeleton 22, and define the appearance and shape of the upper waist part of the robot. In some embodiments, the waist outer skeleton upper rear part 2132 may be further threadedly fixed to the waist outer skeleton upper front part 2131.

In some embodiments, two fifth positioning holes 2131a and two fifth positioning pins 2121c may be provided, wherein the two fifth positioning holes 2131a are respectively disposed on two ends of a surface of the waist outer skeleton upper front part 2131 facing towards the waist outer skeleton middle front part 2121, and two fifth positioning pins 2121c are disposed on two ends of a surface of the waist outer skeleton middle front part 2121 facing towards the waist outer skeleton upper front part 2131. When the waist outer skeleton upper front part 2131 is assembled to the waist outer skeleton middle front part 2121, the two fifth positioning pins 2121c are simultaneously inserted into the two fifth positioning holes 2131a, such that the connection between the waist outer skeleton upper front part 2131 and the waist outer skeleton middle front part 2121 is more reliable. Similarly, two sixth positioning holes 2132.a and two sixth positioning pins 2122c may be provided, and one sixth positioning hole 2132a is inserted into one sixth positioning pin 2122.

Nevertheless, in some other embodiments, the fifth positioning hole 2131a, the fifth positioning pin 2121c, the sixth positioning hole 2132a, and sixth positioning pin 2122c may be provided in other quantities, which are not described herein any further.

It should be noted that the waist outer skeleton upper front part 2131 may be connected to the waist outer skeleton middle front part 2121, the waist outer skeleton upper rear part 2132 may be connected to the waist outer skeleton upper front part 2131, and the waist outer skeleton upper rear part 2132 may be connected to the sixth positioning pin 2122 in other modes other than the connection modes as described above, which are not described herein any further.

The waist outer skeleton 21 is divided into the waist outer skeleton lower part 211, the waist outer skeleton middle part 212, and the waist outer skeleton upper part 213; wherein the waist outer skeleton lower part 211 includes the waist outer skeleton left lower part 2111 and the waist outer skeleton right lower part 2112; the waist outer skeleton middle part 212 includes the waist outer skeleton middle front part 2121 and the waist outer skeleton middle rear part 2122; and the waist outer skeleton upper part 213 includes the waist outer skeleton upper front part 2131 and the waist outer skeleton upper rear part 2132, such that the modularized design of the waist outer skeleton 21 is implemented. All the modules of the waist outer skeleton 21 are connected by insertion or threading, which is favorable to assembling, repair, and part replacement of the waist outer skeleton 21. According to the embodiments of the present application, if the waist outer skeleton 21 partially fails, only the failed component of the waist outer skeleton 21 needs to be replaced, with no need to replace the whole waist outer skeleton 21, and thus the cost is reduced. Nevertheless, with respect to different types of waist inner skeletons 22, sizes or structures thereof are different. Correspondingly, the waist outer skeleton 21 may also have different modularized division designs, which are not described herein any further.

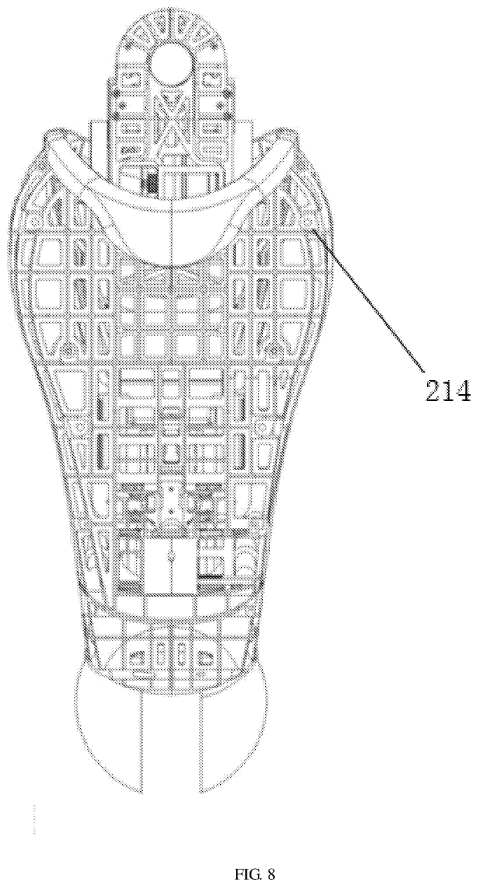

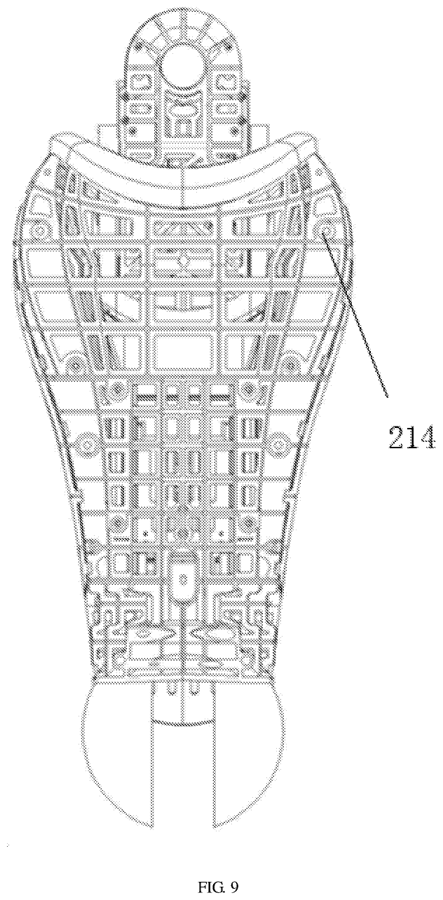

In some embodiments, as illustrated in FIG. 8 and FIG. 9, surfaces of the waist outer skeleton lower part 211, the waist outer skeleton middle part 212, and the waist outer skeleton upper part 213 that are distal from the waist inner skeleton 22 are each provided with a skin positioning groove 214. The skin positioning groove 214 is configured to connect an outer skin of the robot waist. In this way, the whole waist outer skeleton 21 is covered, and the appearance of the robot waist is defined.

In some other embodiments, the waist outer skeleton 21 is made of a lightweight plastic material, and may be manufactured by an injection-molding process. This process features lower cost and fewer restrictions on the appearance and shape, and thus diversified appearances of the robots may be achieved; such that the overall weight of the robot waist may be lowered, and the robot is light-weighted.

For better understanding of the inventive concepts of the present application, description of the assembling process of the waist skeleton is given herein as follows:

The waist outer skeleton left lower part 2111 and the waist outer skeleton right lower part 2112 are threaded to the lower part of the waist inner skeleton 22. In this situation, one surface of the waist outer skeleton left lower part 2111 abuts against one surface of the waist outer skeleton right lower part 2112, and then the two surfaces are threaded. In the meantime, the first positioning pin 2111a is inserted into the first positioning hole 2121a, and the second positioning pin 2112a is inserted into the second positioning hole 2121b. In the meantime, the third positioning pin 2111b is inserted into the third positioning hole 2122a, and the fourth positioning pin 2112b is inserted into the fourth positioning hole 2122b. In this situation, one surface of the waist outer skeleton middle front part 2121 abuts against one surface of the waist outer skeleton middle rear part 2122, and then the two surfaces are threaded. The fifth positioning pin 2121c is inserted into the fifth positioning hole 2131a. The sixth positioning pin 2122c is inserted into the sixth positioning hole 2132a. In this situation, one surface of the waist outer skeleton upper front part 2131 abuts against one surface of the waist outer skeleton upper rear part 2132, and then the two surfaces are threaded.

It may be understood that the waist skeleton may be assembled in other modes other than the mode as described above, which are not described herein any further.

In the embodiment of the present application, the robot waist skeleton 20 is divided into the waist inner skeleton 22 and the waist outer skeleton 21. The waist inner skeleton 22 is configured to define each movement joint of the robot waist, and the waist outer skeleton 21 is configured to define the appearance and shape of the robot waist, and wrap and protect the waist inner skeleton 22. When the appearance and shape of the robot waist needs to be changed, the waist outer skeleton may be directly replaced, with no need to wholly replace the robot waist skeleton. In this way, the cost is lowered. In addition, the waist outer skeleton 21 is made of a lightweight plastic material, which may lower the cost, reduce an overall weight of the robot waist, and make the robot lighter.

An embodiment of the present application further provides a robot. The robot includes a robot waist skeleton. The structure and functionality of the robot waist skeleton are the same as those of the robot waist skeleton as described in the above embodiments. For details of the structure and functionality, reference may be made to the above embodiments, which are not described herein any further.

It should be finally noted that the above-described embodiments are merely for illustration of the present application but are not intended to limit the present application. Although the present application is described in detail with reference to these embodiments, a person skilled in the art may also make various modifications to the technical solutions disclosed in the embodiments or make equivalent replacements to a part of or all technical features contained therein. Such modifications or replacement, made without departing from the principles of the present application, shall fall within the scope defined by the claims and the specification of the present application. Especially, various technical features mentioned in various embodiments may be combined in any mode as long as there is no structural conflict. The present application is not limited to the specific embodiments described herein in this specification, but also includes all the technical solutions falling within the scope subject to the appended claims.

1. A robot waist skeleton, comprising:
a waist inner skeleton; and
a waist outer skeleton, surrounding the waist inner skeleton, the waist outer skeleton being connected to the waist inner skeleton.

2. The robot waist skeleton according to claim 1, wherein the waist outer skeleton comprises a waist outer skeleton lower part, a waist outer skeleton middle part, and a waist outer skeleton upper part; wherein
the waist outer skeleton lower part is connected to the waist inner skeleton; and
the waist outer skeleton lower part, the waist outer skeleton middle part, and the waist outer skeleton upper part are connected in sequence, and all surround the waist inner skeleton.

3. The robot waist skeleton according to claim 2, wherein
the waist outer skeleton lower part comprises a waist outer skeleton left lower part and a waist outer skeleton right lower part; and
the waist outer skeleton left lower part and the waist outer skeleton right lower part are respectively fixed to two sides at a lower part of the waist inner skeleton.

4. The robot waist skeleton according to claim 3, wherein
the waist outer skeleton middle part comprises a waist outer skeleton middle front part and a waist outer skeleton middle rear part; and
the waist outer skeleton middle front part is connected to the waist outer skeleton left lower part and the waist outer skeleton right lower part respectively, the waist outer skeleton middle rear part is connected to the waist outer skeleton left lower part and the waist outer skeleton right lower part respectively, the waist outer skeleton middle front part is connected to the waist outer skeleton middle rear part, and the waist outer skeleton middle front part and the waist outer skeleton middle rear part surround a middle part of the waist inner skeleton.

5. The robot waist skeleton according to claim 4, wherein
the waist outer skeleton left lower part is provided with a first positioning pin, and the waist outer skeleton right lower part is provided with a second positioning pin; and
the waist outer skeleton middle front part is provided with a first positioning hole and a second positioning hole, the first positioning pin being inserted into the first positioning hole, and the second positioning pin being inserted into the second positioning hole.

6. The robot waist skeleton according to claim 4, wherein
the waist outer skeleton left lower part is provided with a third positioning pin, and the waist outer skeleton right lower part is provided with a fourth positioning pin; and
the waist outer skeleton middle rear part is provided with a third positioning hole and a fourth positioning hole, the third positioning pin being inserted into the third positioning hole, and the fourth positioning pin being inserted into the fourth positioning hole.

7. The robot waist skeleton according to claim 4, wherein
the waist outer skeleton upper part comprises a waist outer skeleton upper front part and a waist outer skeleton upper rear part; and
the waist outer skeleton upper front part is connected to the waist outer skeleton middle front part, the waist outer skeleton upper rear part is connected to the waist outer skeleton middle rear part, the waist outer skeleton upper front part is connected to the waist outer skeleton upper rear part, and the waist outer skeleton upper front part and the waist outer skeleton upper rear part surround an upper part of the waist inner skeleton.

8. The robot waist skeleton according to claim 7, wherein
the waist outer skeleton middle front part is provided with a fifth positioning pin, and the waist outer skeleton upper front part is provided with a fifth positioning hole, the fifth positioning pin being inserted into the fifth positioning hole.

9. The robot waist skeleton according to claim 7, wherein
the waist outer skeleton middle rear part is provided with a sixth positioning pin, and the waist outer skeleton upper rear part is provided with a sixth positioning hole, the sixth positioning pin being inserted into the sixth positioning hole.

10. The robot waist skeleton according to claim 3, wherein surfaces of the waist outer skeleton lower part, the waist outer skeleton middle part, and the waist outer skeleton upper part that are distal from the waist inner skeleton are each provided with a skin positioning groove.

11. The robot waist skeleton according to claim 1, wherein the waist outer skeleton is made of a lightweight material.

12. A robot, comprising the robot waist skeleton as defined in claim 1.
